(19) United States
(12) Patent Application Publication
(10) Pub. No.: US 2024/0211569 A1
(43) Pub. Date: Jun. 27, 2024

(54) Biometric Multi-Representation Eye Authentication

(71) Applicant: Apple Inc., Cupertino, CA (US)

(72) Inventors: Gendong Zhang, Stanford, CA (US); Martin Haller, Mountain View, CA (US); Abhishek Nagar, Seattle, WA (US); Saurabh Jain, Saratoga, CA (US); Stefan Roennecke, Santa Clara, CA (US); Tomi P Maila, San Carlos, CA (US); Andrei Nikiforov, Berlin (DE); Tom Sengelaub, Oakland, CA (US)

(73) Assignee: Apple Inc., Cupertino, CA (US)

(21) Appl. No.: 18/534,346

(22) Filed: Dec. 8, 2023

Related U.S. Application Data
(60) Provisional application No. 63/476,930, filed on Dec. 22, 2022.

(51) Int. Cl. G06F 21/32; G06V 40/18; G06V 40/19

(52) U.S. Cl. CPC G06F 21/32; G06V 40/19; G06V 40/193; G06V 40/197

(57) ABSTRACT

Methods for performing user authentication based on a multi-representation eye model for devices such as head-mounted display devices are disclosed. The multi-representation eye model may be generated and updated based on feature representations of an identified eye. The user authentication process may be initiated by causing an image to be captured of a current eye under a first set of conditions that may then be transformed into a current feature representation. The current feature representation may be applied to the multi-representation eye model to determine whether the current eye is a match for the identified eye.

### PRIORITY APPLICATION

This application claims benefit of priority to U.S. Provisional Application Ser. No. 63/476,930, entitled “Biometric Multi-Representation Eye Authentication,” filed Dec. 22, 2022, and which is hereby incorporated herein by reference in its entirety.

### BACKGROUND

Extended reality (XR) systems such as mixed reality (MR) or augmented reality (AR) systems combine computer generated information (referred to as virtual content) with real world images or a real-world view to augment, or add content to, a user's view of the world. XR systems may thus be utilized to provide an interactive user experience for multiple applications, such as applications that add virtual content to a real-time view of the viewer's environment, interacting with virtual training environments, gaming, remotely controlling drones or other mechanical systems, viewing digital media content, interacting with the Internet, or the like.

### SUMMARY

Various embodiments of methods and apparatus for multi-representation eye authentication for use of a device, for example head-mounted devices (HMDs) including but not limited to HMDs used in extended reality (XR) applications and systems, are described. HMDs may include wearable devices such as headsets, helmets, goggles, or glasses. An XR system may include an HMD which may include one or more cameras that may be used to capture still images or video frames of the user's environment. The HMD may include lenses positioned in front of the eyes through which the wearer can view the environment. In XR systems, virtual content may be displayed on or projected onto these lenses to make the virtual content visible to the wearer while still being able to view the real environment through the lenses.

In some systems, a user authentication process may be performed based on a user's eye. During the user authentication process, the eye of the user that is trying to be authenticated may be compared to an identified eye that has been authenticated by using a multi-representation eye model. The multi-representation eye model may be based on feature representations of images of the identified eye captured under a plurality of different sets of conditions.

In such systems, to build the multi-representation eye model, images of an eye known as the identified eye may be captured at different times under different sets of conditions. A set of conditions may include one or more of lighting affecting the identified eye, pose of the identified eye, accommodation distance of the identified eye, or indication of force applied to the identified eye. The images may then be transformed into feature representations for the identified eye. A feature representation includes features from the image that represent different 3D topography, structures, or textures of an eye and is made to be inputted into the multi-representation eye model.

The multi-representation eye model for the identified eye may then be generated based on the feature representations. Feature representations of different sets of conditions may be added until the multi-representation eye model reaches a maximum amount of feature representations. Feature representations may also replace existing feature representations in the multi-representation eye model based on a quality indicator or an age of the existing feature representations. In some systems, the multi-representation eye model may be updated during use of the device by the user of the identified eye. The multi-representation eye model may be updated during times when it is unobtrusive for the user.

In some systems, to update the multi-representation eye model, a new set of conditions affecting the identified eye may be determined and whether the new set of conditions are sufficiently represented in the multi-representation eye model may be determined. In such systems that the new set of conditions are not sufficiently represented, a new image of the identified eye may be captured under the new set of conditions and transformed into a new feature representation. The multi-representation eye model may be updated based on the new feature representation and stored for using during a user authentication process.

To perform the user authentication process, an image may be captured of a current eye of a user attempting to login to the account with multi-representation eye model for the identified eye under a first set of conditions. The image may then be transformed into a current feature representation for the current eye. After accessing the multi-representation eye model, the current feature representation may be applied to the multi-representation eye model to determine whether the current eye is a match for the identified eye. Then, an indication of whether the current eye is a match for the identified eye may be provided.

### BRIEF DESCRIPTION OF THE DRAWINGS

FIG. 1 is a block diagram illustrating a device, wherein a multi-representation user authentication process is performed by using a multi-representation eye model, according to some embodiments.

FIG. 2 graphically illustrates an eye comprising features under different conditions, according to some embodiments.

FIG. 3 is a block diagram illustrating a multi-representation model builder, wherein a multi-representation eye model generated or updated based on condition-dependent feature representations, according to some embodiments.

FIG. 4 is a block diagram illustrating a multi-representation model storage, wherein the multi-representation model storage comprises condition-dependent feature representations, a condition-independent feature representation, and a condition index, according to some embodiments.

FIG. 5 is a block diagram illustrating a fused multi-representation model based on condition-dependent feature representations, according to some embodiments.

FIGS. 6A-C is a block diagram illustrating example devices in which the methods of FIGS. 1 through 10 may be implemented, according to some embodiments.

FIG. 7 is a flow diagram illustrating a process of generating a multi-representation eye model, according to some embodiments.

FIG. 8 is a flow diagram illustrating a process of updating a multi-representation eye model, based on whether the different sets of conditions are sufficiently represented in the multi-representation eye model, according to some embodiments.

FIG. 9 is a flow diagram illustrating a process of user authentication based on applying a current feature representation to a multi-representation eye model according to some embodiments.

FIG. 10 is a flow diagram illustrating a process of determining whether a current eye is a match for an identified eye of the multi-representation eye model.

This specification includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

“Comprising.” This term is open-ended. As used in the claims, this term does not foreclose additional structure or steps. Consider a claim that recites: “An apparatus comprising one or more processor units . . . . ” Such a claim does not foreclose the apparatus from including additional components (e.g., a network interface unit, graphics circuitry, etc.).

“Configured To.” Various units, circuits, or other components may be described or claimed as “configured to” perform a task or tasks. In such contexts, “configured to” is used to connote structure by indicating that the units/circuits/components include structure (e.g., circuitry) that performs those task or tasks during operation. As such, the unit/circuit/component can be said to be configured to perform the task even when the specified unit/circuit/component is not currently operational (e.g., is not on). The units/circuits/components used with the “configured to” language include hardware—for example, circuits, memory storing program instructions executable to implement the operation, etc. Reciting that a unit/circuit/component is “configured to” perform one or more tasks is expressly intended not to invoke 35 U.S.C. § 112, paragraph (f), for that unit/circuit/component. Additionally, “configured to” can include generic structure (e.g., generic circuitry) that is manipulated by software or firmware (e.g., an FPGA or a general-purpose processor executing software) to operate in manner that is capable of performing the task(s) at issue. “Configure to” may also include adapting a manufacturing process (e.g., a semiconductor fabrication facility) to fabricate devices (e.g., integrated circuits) that are adapted to implement or perform one or more tasks.

“First,” “Second,” etc. As used herein, these terms are used as labels for nouns that they precede, and do not imply any type of ordering (e.g., spatial, temporal, logical, etc.). For example, a buffer circuit may be described herein as performing write operations for “first” and “second” values. The terms “first” and “second” do not necessarily imply that the first value must be written before the second value.

It will also be understood that, although the terms 1, 2, N, etc. may be used herein to describe various elements, these elements should not be limited by these terms. These terms are only used to distinguish one element from another. For example, a component with the term 1 could be termed a second component, and, similarly, a component with the term 2 could be termed a first component, without departing from the scope of the present invention. The first components and the second component are both components, but they are not the same components. Also, the term N indicates that an Nth amount of the elements may or may not exist depending on the embodiments.

“Based On” or “Dependent On.” As used herein, these terms are used to describe one or more factors that affect a determination. These terms do not foreclose additional factors that may affect a determination. That is, a determination may be solely based on those factors or based, at least in part, on those factors. Consider the phrase “determine A based on B.” While in this case, B is a factor that affects the determination of A, such a phrase does not foreclose the determination of A from also being based on C. In other instances, A may be determined based solely on B.

“Or.” When used in the claims, the term “or” is used as an inclusive or and not as an exclusive or. For example, the phrase “at least one of x, y, or z” means any one of x, y, and z, as well as any combination thereof.

### DETAILED DESCRIPTION

Various embodiments of methods and apparatus for multi-representation user authentication using a multi-representation eye model of a device, for example head-mounted devices (HMDs) including but not limited to HMDs used in extended reality (XR) applications and systems, are described. HMDs may include wearable devices such as headsets, helmets, goggles, or glasses. An XR system may include an HMD which may include one or more cameras that may be used to capture still images or video frames of the user's environment. The HMD may include lenses positioned in front of the eyes through which the wearer can view the environment. In XR systems, virtual content may be displayed on or projected onto these lenses to make the virtual content visible to the wearer while still being able to view the real environment through the lenses.

In at least some systems, the HMD may include user login processes. In some cases, the user login processes may include a user authentication process to ensure the account matches the correct user. In an example, one or more cameras may capture an image of a user's eye. By comparing the user's eye to an identified eye connected to the account and represented in a multi-representation eye model, the user's eye may be determined to be a match for the identified eye and therefore may be logged in to the account on the HMD. If the user's eye is determined to not be a match for the identified eye, then the user may be unable to log in to the account on the HMD using this method or may have to redo the user authentication process using this method.

In such systems, to build the multi-representation eye model, a first image of an eye known as the identified eye may be captured at a first time under a first set of conditions. A set of conditions may include one or more of lighting affecting the identified eye, pose of the identified eye, accommodation distance of the identified eye, or indication of force applied to the identified eye. The first image may then be transformed into a first feature representation for the identified eye. A feature representation includes features from the image that represent different 3D topography, structures, or textures of an eye and is made to be inputted into the multi-representation eye model. A second image of the identified eye may then be captured at a second time after the first time under a second set of conditions different than the first set of conditions. The second image may be transformed into a second feature representation for the identified eye.

The multi-representation eye model for the identified eye may then be generated based on the first feature representation and the second feature representation. Building the multi-representation eye model may be performed during an enrollment process initiated for eye authentication for a user. The multi-representation eye model may be generated at a time during use of the device. The multi-representation eye model may be updated with other feature representations. Feature representations of different sets of conditions may be added until the multi-representation eye model reaches a maximum amount of feature representations. Feature representations may also replace existing feature representations in the multi-representation eye model based on a quality indicator or an age of the existing feature representations. In some systems, the multi-representation eye model may be updated during use of the device by the user of the identified eye. The multi-representation eye model may be updated during times when it is unobtrusive for the user.

In some systems, to update the multi-representation eye model, a new set of conditions affecting the identified eye may be determined and whether the new set of conditions are sufficiently represented in the multi-representation eye model may be determined. In such systems that the new set of conditions are not sufficiently represented, a new image of the identified eye may be captured under the new set of conditions. The new image may be transformed into a new feature representation and then the multi-representation eye model for the identified eye may then be updated based on the new feature representation. The multi-representation eye model may be stored for using during a user authentication process. In some embodiments, to generate or update the multi-representation eye model, a machine learning model may be trained for the multi-representation eye model using the feature representations. In some embodiments, the feature representations may be separately stored as part of the multi-representation eye model.

To perform the user authentication process, an image may be captured of a current eye of a user attempting to login to the account with multi-representation eye model for the identified eye under a first set of conditions. The image may then be transformed into a current feature representation for the current eye. After accessing the multi-representation eye model, the current feature representation may be applied to the multi-representation eye model to determine whether the current eye is a match for the identified eye. Then, an indication of whether the current eye is a match for the identified eye may be provided.

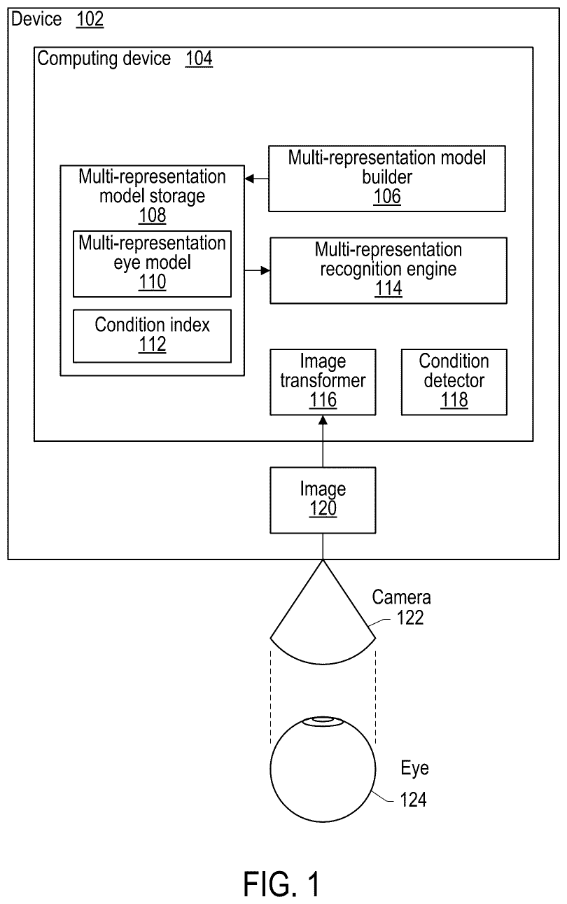

FIG. 1 is a block diagram illustrating a device, wherein a multi-representation user authentication process is performed by using a multi-representation eye model, according to some embodiments.

In some embodiments, a device performing a user authentication process by using a multi-representation eye model, such as a multi-representation eye model 110, may resemble embodiments as shown in FIG. 1. In some embodiments, a multi-representation eye model 110, may include different feature representations for each of the different sets of conditions. A multi-representation eye model 110 may include a fused model in some embodiments, wherein the different feature representations are combined into one model.

In some embodiments, the device 102 may comprise a computing device 104. In such embodiments, a camera 122 may capture an image 120 of an eye 124. A condition detector 118 may receive the set of conditions of the eye. Conditions may include but are not limited to lighting affecting the eye, pose of the eye, accommodation distance for the eye, or indication of force applied to the eye. The image transformer 116 may then receive the image 120.

The image transformer 116 may transform the image 120 into a feature representation that may be sent to the multi-representation recognition engine 114 or the multi-representation model builder 106. During a process of generating or updating the multi-representation eye model 110, the feature representation of the image 120 may be sent to the multi-representation model builder 106. During a process of user authentication, the feature representation of the image 120 may be sent to the multi-representation recognition engine 114. Feature representations may include features that represent different 3D topography, structures, or textures of the eye captured under a set of conditions. The multi-representation model builder 106 may build a multi-representation eye model and store the multi-representation eye model into a multi-representation model storage 108. The multi-representation recognition engine 114 may then access the multi-representation eye model 110 during a user authentication process to determine whether the eye of a current feature representation matches the identified eye of the multi-representation eye model 110.

In some embodiments, the multi-representation recognition engine 114, may access a condition index 112 to determine corresponding one or more feature representations of the multi-representation eye model based on the set of conditions from the current feature representation. The corresponding one ore more feature representations of the multi-representation eye model 110 may then be compared to the current feature representation to determine whether the eye of the current feature representation matches the identified eye of the multi-representation eye model 110. For example, if two feature representations of the multi-representations eye model have the same lighting affecting the eye and accommodation of the eye as the current feature representation, then these two feature representations may be accessed and compared to the current feature representation using the condition index 112.

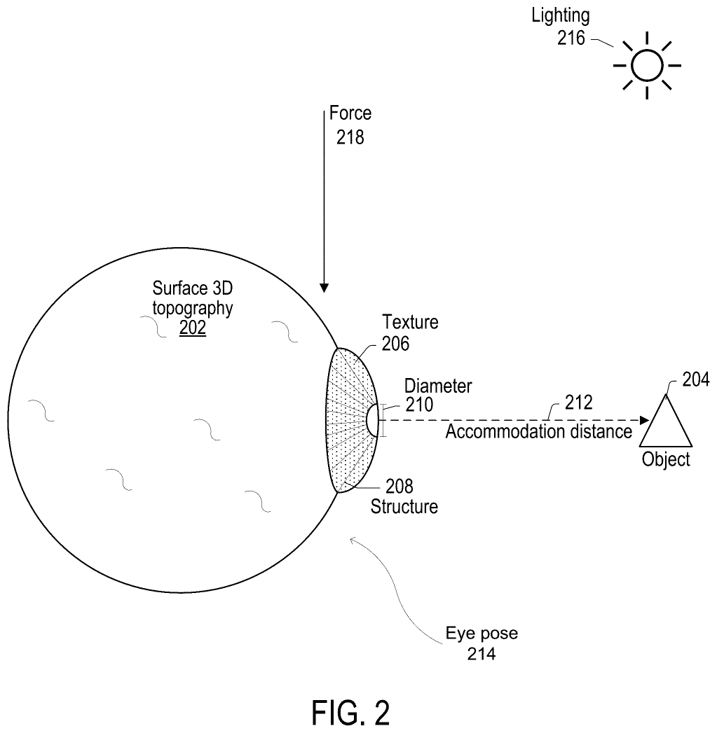

FIG. 2 graphically illustrates an eye comprising features under different conditions, according to some embodiments.

Some embodiments, such as shown in FIG. 1, may include further features such as shown in FIG. 2. In some embodiments, the eye 124 being captured by the camera 122 may include surface 3D topography 202, structures 208, or textures 206 and experience different sets of conditions depending on the situation. Depending on the conditions experienced by the eye 124, the features of a feature representation that represent the surface 3D topography 202, the structures 208, the textures 206, or the diameter 210 of the pupil may be different. Examples of different conditions include but are not limited to, force 218, lighting 216, accommodation distance 212, and eye pose 214. Accommodation distance represents the distance away an object 204 is that eye is focusing on. The eye pose 214 may represent the position of the eye and may change depending on the direction the eye is looking. The force 218 may represent any force occurring to the eye.

Features, as described above, of a current feature representation may be compared to features of the multi-representation model 110 to determine whether a current eye of the current feature representation is a match for an identified eye of the multi-representation model. In some embodiments, a feature representation may include dependent features that are dependent on the feature representation's set of conditions and independent features that are independent of the feature representation's set of conditions. In some embodiments, to compare the features of a current feature representations to features of the multi-representation model 110, dependent current features may be compared to dependent model features and independent current features may be compared to independent model features.

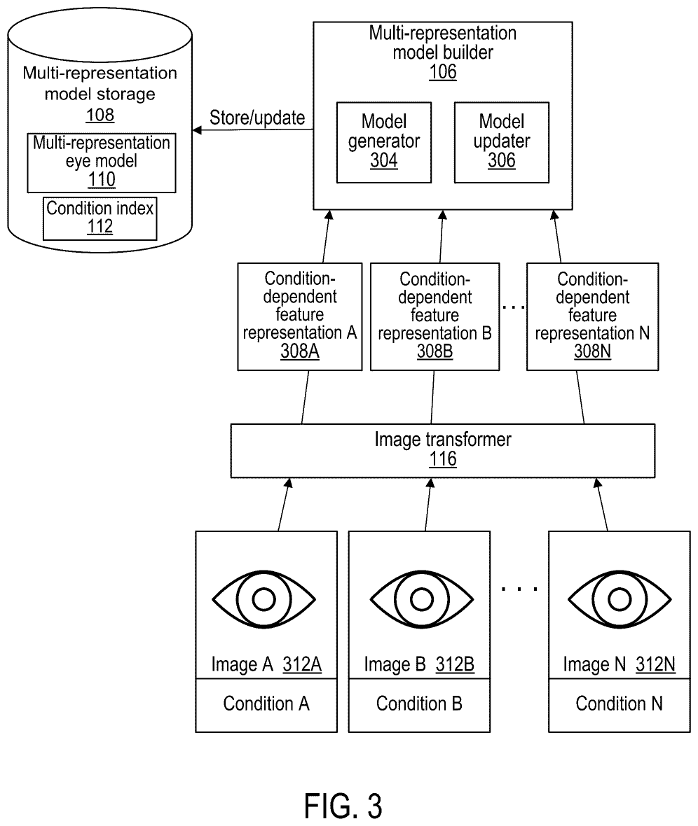

FIG. 3 is a block diagram illustrating a multi-representation model builder, wherein a multi-representation eye model generated or updated based on condition-dependent feature representations, according to some embodiments.

Some embodiments, such as shown in FIGS. 1-2, may include further features such as shown in FIG. 3. In such embodiments, images A, B, and N (312A, 312B, 312N) including conditions A, B, N may be provided to the image transformer 116. The image transformer 116 may then output and send condition-dependent feature representations A, B, and N (308A, 308B, 308N) to the multi-representation model builder 106.

In some embodiments, a model generator 304 may generate the multi-representation eye model 110 based on the condition-dependent feature representations A, B, and N (308A, 308B, 308N) and may store the multi-representation eye model 110 into the multi-representation model storage 108. In some embodiments, a model updater 306 may update the multi-representation eye model 110 into the multi-representation model storage 108 based on the condition-dependent feature representations A, B, and N (308A, 308B, 308N). The condition index 112 that contains data indicating which sets of conditions apply to each of the condition-dependent feature representations may also be stored into the multi-representation model storage 108.

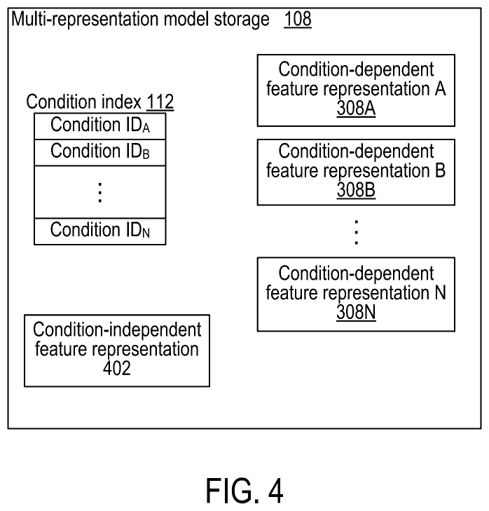

FIG. 4 is a block diagram illustrating a multi-representation model storage, wherein the multi-representation model storage comprises condition-dependent feature representations, a condition-independent feature representation, and a condition index, according to some embodiments.

Some embodiments, such as shown in FIGS. 1-3, may include further features such as shown in FIG. 4. The multi-representation model storage 108 may include separate feature representations such as condition-dependent feature representation A 308 A, condition-dependent feature representation B 308, condition-dependent feature representation N 308N, and condition-independent feature representation 402. The condition-independent feature representation 402 may represent features that are independent of any conditions.

The condition index 112 may include condition IDs that indicate the conditions that each of the condition-dependent feature representations are dependent on. In some embodiments, to apply the current feature representation to the multi-representation model storage 108, the condition-independent feature representation 402, the condition-dependent feature representation A 308 A, the condition-dependent feature representation B 308, and the condition-dependent feature representation N 308N may be compared to the current feature representation.

In some embodiments, a select amount of the condition-dependent feature representations may be chosen in addition to the condition-independent feature representation 402 to be compared to the current feature representation. In such embodiments, the selected condition-dependent feature representations may be selected based on the set of conditions of the current feature representation. The selection may be performed by accessing the condition index 112 to determine condition-dependent feature representations that have sets of conditions that correspond to the current feature's set of conditions. For example, if the current feature representation's set of conditions included a high brightness of light affecting the current eye, then condition-dependent feature representations that have a high brightness of light affecting the identified eye included in their sets of conditions may be selected for comparison to the current feature representation.

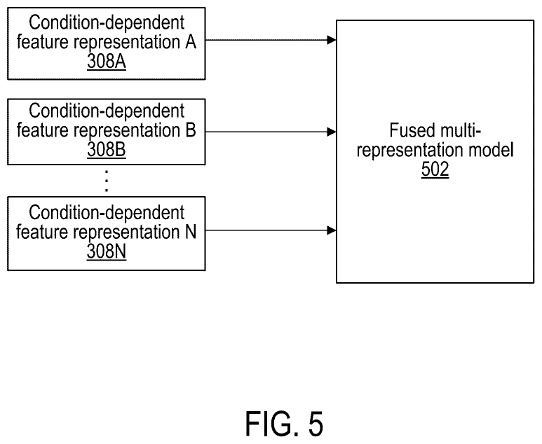

FIG. 5 is a block diagram illustrating a fused multi-representation model based on condition-dependent feature representations, according to some embodiments.

Some embodiments, such as shown in FIGS. 1-3, may include further features such as shown in FIG. 5. In such embodiments, the multi-representation model 110 may be a fused multi-representation model 502. The condition-dependent feature representations A, B, and N (308A, 308B, and 308N) may be inputted into the fused multi-representation model 502 to become one fused model. To apply the current feature representation to the multi-representation eye model 110, the current feature representation may be applied directly to the fused multi-representation model 502.

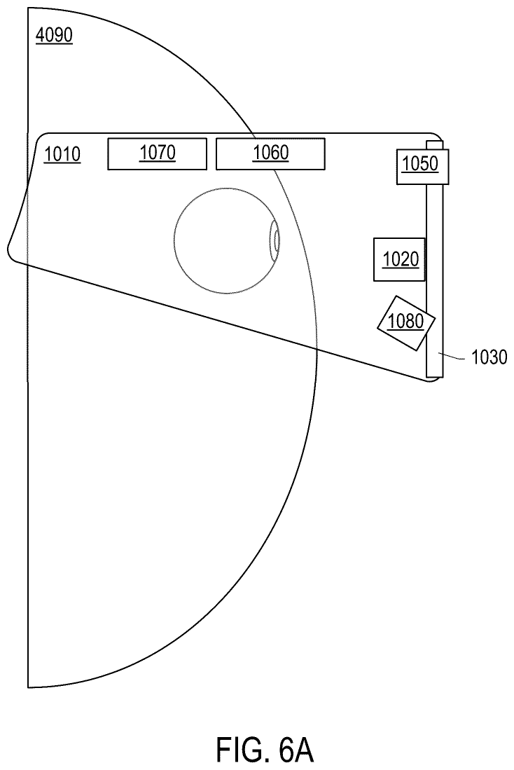

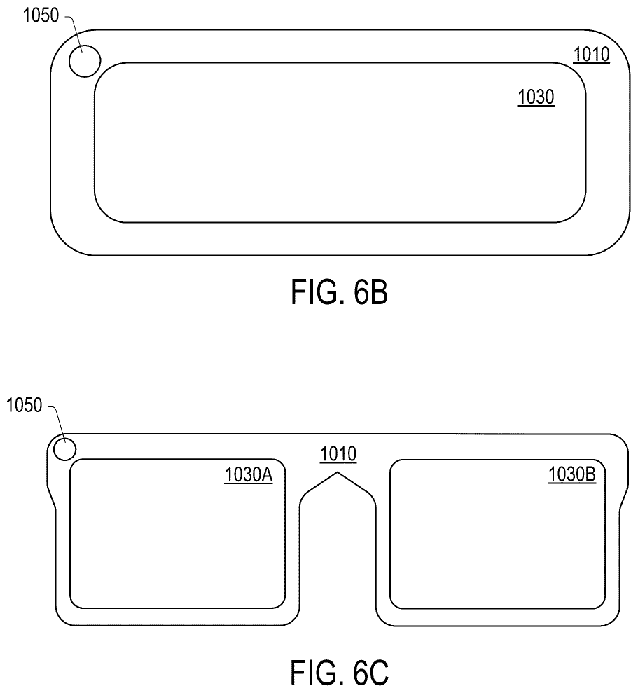

FIGS. 6A-C is a block diagram illustrating example devices in which the methods of FIGS. 1 through 10 may be implemented, according to some embodiments.

FIGS. 6A-C illustrates an example head-mounted device (HMD) that may include components and implement methods as illustrated in FIGS. 1 through 10, according to some embodiments. As shown in FIG. 6A, the HMD may be positioned on the user's head 4090 such that the display is disposed in front of the user's eyes. The user looks through the eyepieces onto the display.

FIGS. 6A-C illustrate example devices in which the methods of FIGS. 1 through 5 may be implemented, according to some embodiments. Note that the HMDs as illustrated in FIGS. 6A through 6C are given by way of example, and are not intended to be limiting. In various embodiments, the shape, size, and other features of an HMD may differ, and the locations, numbers, types, and other features of the components of an HMD and of the eye imaging system. FIG. 6A shows a side view of an example HMD, and FIGS. 6B and 6C show alternative front views of example HMDs, with FIG. 6B showing device that has one lens 1030 that covers both eyes and FIG. 6C showing a device that has right 1030A and left 1030B lenses.

The HMD may include lens(es) 1030, mounted in a wearable housing or frame 1010. The HMD may be worn on a user's head (the “wearer”) so that the lens(es) is disposed in front of the wearer's eyes. In some embodiments, an HMD may implement any of various types of display technologies or display systems. For example, the HMD may include a display system that directs light that forms images (virtual content) through one or more layers of waveguides in the lens(es) 1020; output couplers of the waveguides (e.g., relief gratings or volume holography) may output the light towards the wearer to form images at or near the wearer's eyes.

As another example, the HMD may include a direct retinal projector system that directs light towards reflective components of the lens(es); the reflective lens(es) is configured to redirect the light to form images at the wearer's eyes. In some embodiments the display system may change what is displayed to at least partially affect the conditions and features of the eye for the purpose of generating or updating the multi-representation eye model. For example, the display may increase the brightness to change the conditions of the eye such as lighting that is affecting the eye. Another example, the display may change the distance an object appears on the display to affect the conditions of the eye such as the accommodation distance of the eye.

In some embodiments, HMD may also include one or more sensors that collect information about the wearer's environment (video, depth information, lighting information, etc.) and about the wearer (e.g., eye or gaze sensors). The sensors may include one or more of, but are not limited to one or more eye cameras 1020 (e.g., infrared (IR) cameras) that capture views of the user's eyes, one or more world-facing or PoV cameras 1050 (e.g., RGB video cameras) that can capture images or video of the real-world environment in a field of view in front of the user, and one or more ambient light sensors that capture lighting information for the environment. Cameras 1020 and 1050 may be integrated in or attached to the frame 1010. The HMD may also include one or more light sources 1080 such as LED or infrared point light sources that emit light (e.g., light in the IR portion of the spectrum) towards the user's eye or eyes.

A controller 1060 for the XR system may be implemented in the HMD, or alternatively may be implemented at least in part by an external device (e.g., a computing system or handheld device) that is communicatively coupled to the HMD via a wired or wireless interface. Controller 1060 may include one or more of various types of processors, image signal processors (ISPs), graphics processing units (GPUs), coder/decoders (codecs), system on a chip (SOC), CPUs, and/or other components for processing and rendering video and/or images. In some embodiments, controller 1060 may render frames (each frame including a left and right image) that include virtual content based at least in part on inputs obtained from the sensors and from an eye authentication system, and may provide the frames to the display system.

Memory 1070 for the XR system may be implemented in the HMD, or alternatively may be implemented at least in part by an external device (e.g., a computing system) that is communicatively coupled to the HMD via a wired or wireless interface. The memory 1070 may, for example, be used to record video or images captured by the one or more cameras 1050 integrated in or attached to frame 1010. Memory 1070 may include any type of memory, such as dynamic random-access memory (DRAM), synchronous DRAM (SDRAM), double data rate (DDR, DDR2, DDR3, etc.) SDRAM (including mobile versions of the SDRAMs such as mDDR3, etc., or low power versions of the SDRAMs such as LPDDR2, etc.), RAMBUS DRAM (RDRAM), static RAM (SRAM), etc.

In some embodiments, one or more memory devices may be coupled onto a circuit board to form memory modules such as single inline memory modules (SIMMs), dual inline memory modules (DIMMs), etc. Alternatively, the devices may be mounted with an integrated circuit implementing system in a chip-on-chip configuration, a package-on-package configuration, or a multi-chip module configuration. In some embodiments DRAM may be used as temporary storage of images or video for processing, but other storage options may be used in an HMD to store processed data, such as Flash or other “hard drive” technologies. This other storage may be separate from the externally coupled storage mentioned below.

While FIG. 6A only shows light sources 1080 and cameras 1020 and 1050 for one eye, embodiments may include light sources 1080 and cameras 1020 and 1050 for each eye, and user authentication may be performed for both eyes. In addition, the light sources, 1080, camera 1020 and PoV camera 1050 may be located elsewhere than shown.

Embodiments of an HMD as illustrated in FIGS. 6A-6C may, for example, be used in augmented or mixed (AR) applications to provide augmented or mixed reality views to the wearer. The HMD may include one or more sensors, for example located on external surfaces of the HMD, that collect information about the wearer's external environment (video, depth information, lighting information, etc.); the sensors may provide the collected information to controller 1060 of the XR system.

The sensors may include one or more visible light cameras 1050 (e.g., RGB video cameras) that capture video of the wearer's environment that, in some embodiments, may be used to provide the wearer with a virtual view of their real environment. In some embodiments, video streams of the real environment captured by the visible light cameras 1050 may be processed by the controller 1060 of the HMD to render augmented or mixed reality frames that include virtual content overlaid on the view of the real environment, and the rendered frames may be provided to the display system.

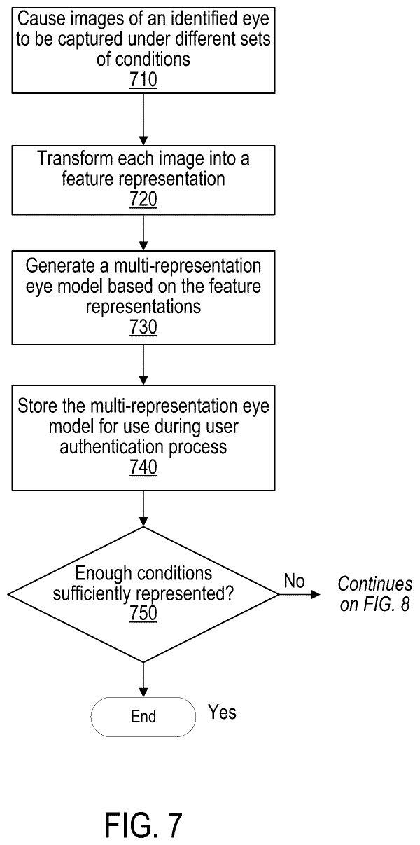

FIG. 7 is a flow diagram illustrating a process of generating a multi-representation eye model, according to some embodiments.

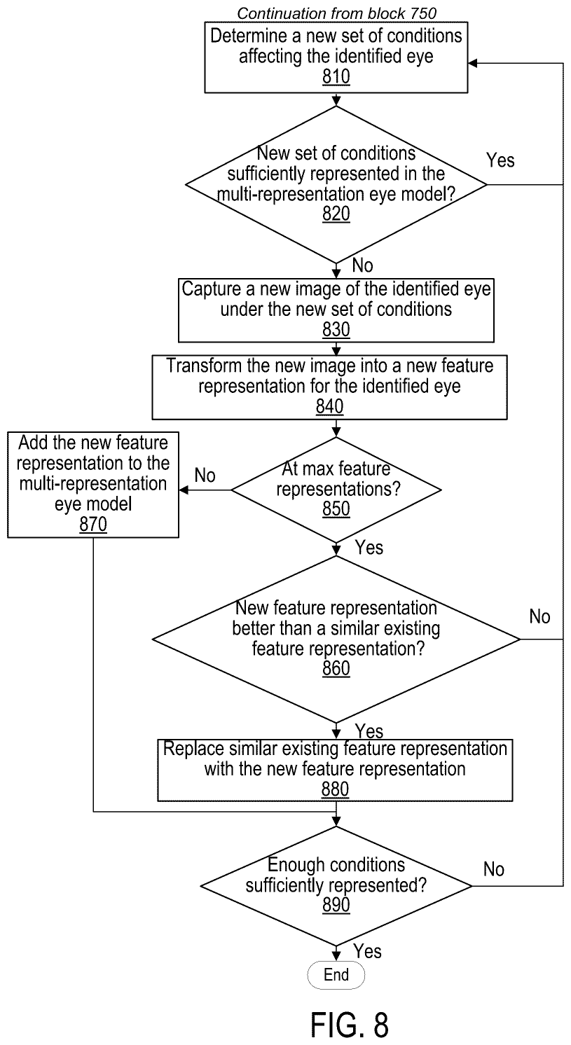

In some embodiments, a process of generating a multi-representation eye model may resemble a process such as that which is shown in FIG. 7. In block 710, images of an identified eye may be caused to be captured under different sets of conditions. For example, the identified eye may be captured in different lighting settings by changing the display brightness of the HMD. In another example, the identified eye may be captured in different lighting settings of the environment naturally occurring around the HMD. In block 720, each image may be transformed into a feature representation. In block 730, a multi-representation eye model based on the feature representations may be generated. In block 740, the multi-representation eye model may be stored for use during a user authentication process. Block 750 checks if enough sets of conditions are sufficiently represented in the multi-representation eye model. If enough sets of conditions are sufficiently represented, then the process ends. If not enough sets of conditions are sufficiently represented, then a process as shown in FIG. 8 may be performed.

FIG. 8 is a flow diagram illustrating a process of updating a multi-representation eye model, based on whether the different sets of conditions are sufficiently represented in the multi-representation eye model, according to some embodiments.

In some embodiments, a process of updating the multi-representation eye model may resemble a process such as that which is shown in FIG. 8. As a continuation from block 750, in block 810 a new set of conditions affecting the identified eye may be determined. Block 820 checks if the new set of conditions are sufficiently represented in the multi-representation eye model. If the new set of conditions are sufficiently represented in the multi-representation eye model, the process continues back to 810. If the new set of conditions are not sufficiently represented in the multi-representation eye model, a new image of the identified eye under the new set of conditions may be captured such as shown in block 830. For example, if the multi-representation eye model does not include a set of conditions that include bright natural lighting affecting the identified eye, then capturing a new image of the identified eye under a new set of conditions that include the bright natural lighting may be performed. In block 840, the new image may be transformed into a new feature representation for the identified eye.

Block 850 checks if the multi-representation eye model has reached a maximum feature representation capacity. If the multi-representation eye model has not reached a maximum, the new feature representation may be added to the multi-representation eye model as shown in block 870. If the multi-representation eye model has reached a maximum, then block 860 checks if the new feature representation is better than a similar existing feature representation, such as by quality or age. A similar existing feature representation may include a feature representation with similar sets of conditions. If the new feature representation is not better than a similar existing feature representation, the process may begin again at block 810.

If the new feature representation is better than a similar existing feature representation, the new feature representation may replace the similar existing feature representation, such as shown in block 880. For example, if the quality of the new feature representation is higher than a similar existing feature representation, then the new feature representation may take the place of the similar existing feature representation in the multi-representation eye model. Both block 870 and block 880 proceed to block 890 that checks if enough conditions have been sufficiently represented in the multi-representation eye model. If not enough conditions have been sufficiently represented, then the process proceeds to block 810. If enough conditions have been sufficiently represented, then the process ends.

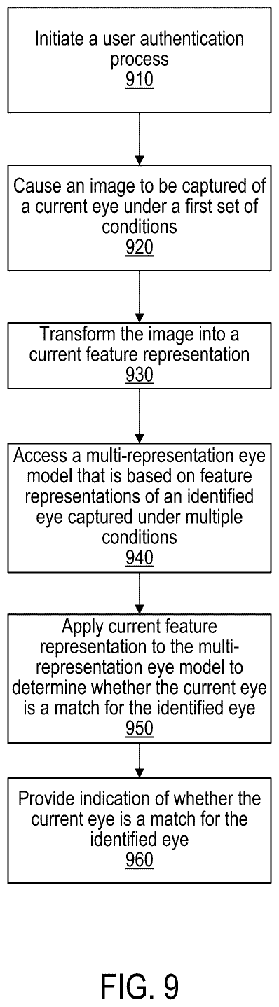

FIG. 9 is a flow diagram illustrating a process of user authentication based on applying a current feature representation to a multi-representation eye model according to some embodiments.

In some embodiments, a process of user authentication based on applying a current feature representation to a multi-representation eye model may resemble a process such as shown in FIG. 9. In block 910, a user authentication process may be initiated. In block 920, an image of a current eye under a first set of conditions may be caused to be captured. In block 930, the image may be transformed into a current feature representation. In block 940, a multi-representation eye model that is based on feature representations of an identified eye captured under multiple conditions may be accessed.

In block 950, a current feature representation may be applied to the multi-representation eye model to determine whether the current eye is a match for the identified eye. In block 950, an indication of whether the current eye is a match for the identified eye may be provided. For example, if the current eye is a match for the identified eye, indication that the current eye is a match for the identified eye may be provided to a display of the device.

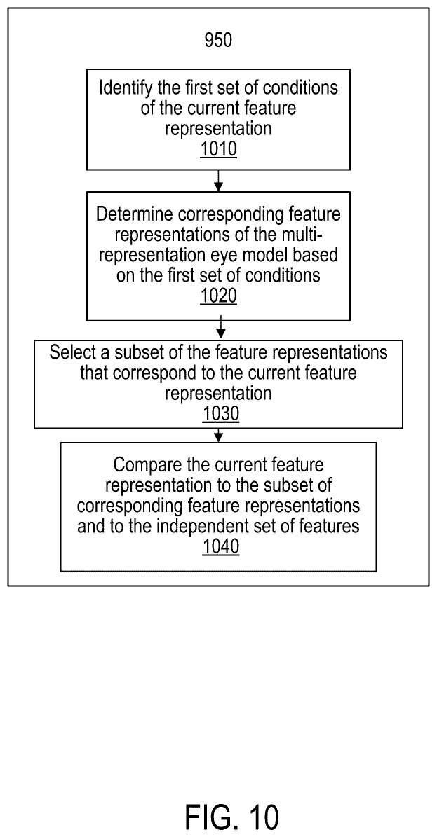

FIG. 10 is a flow diagram illustrating a process of applying the current feature representation to the multi-representation eye model by determining whether a current eye is a match for an identified eye of the multi-representation eye model.

In some embodiments, a process of applying the current feature representation to the multi-representation eye model by determining whether a current eye is a match for an identified eye of the multi-representation eye model may resemble a process such as shown in FIG. 10. Block 950 may include blocks 1010, 1020, 1030, and 1040. In block 1010, the first set of conditions of the current feature representation may be identified. In block 1020, corresponding feature representations of the multi-representation eye model based on the first set of conditions may be determined.

In block 1030, a subset of the feature representations that correspond to the current feature representation may be selected. In block 1040, the current feature representation may be compared to the subset of corresponding feature representations and to an independent set of features. For example, corresponding feature representations may include feature representations that were formed under sets of conditions that are similar to the first set of conditions of the current feature representation.

### Extended Reality

A real environment refers to an environment that a person can perceive (e.g., see, hear, feel) without use of a device. For example, an office environment may include furniture such as desks, chairs, and filing cabinets; structural items such as doors, windows, and walls; and objects such as electronic devices, books, and writing instruments. A person in a real environment can perceive the various aspects of the environment, and may be able to interact with objects in the environment.

An extended reality (XR) environment, on the other hand, is partially or entirely simulated using an electronic device. In an XR environment, for example, a user may see or hear computer generated content that partially or wholly replaces the user's perception of the real environment. Additionally, a user can interact with an XR environment. For example, the user's movements can be tracked and virtual objects in the XR environment can change in response to the user's movements. As a further example, a device presenting an XR environment to a user may determine that a user is moving their hand toward the virtual position of a virtual object, and may move the virtual object in response. Additionally, a user's head position and/or eye gaze can be tracked and virtual objects can move to stay in the user's line of sight.

Examples of XR include augmented reality (AR), virtual reality (VR) and mixed reality (MR). XR can be considered along a spectrum of realities, where VR, on one end, completely immerses the user, replacing the real environment with virtual content, and on the other end, the user experiences the real environment unaided by a device. In between are AR and MR, which mix virtual content with the real environment.

VR generally refers to a type of XR that completely immerses a user and replaces the user's real environment. For example, VR can be presented to a user using a head mounted device (HMD), which can include a near-eye display to present a virtual visual environment to the user and headphones to present a virtual audible environment. In a VR environment, the movement of the user can be tracked and cause the user's view of the environment to change. For example, a user wearing a HMD can walk in the real environment and the user will appear to be walking through the virtual environment they are experiencing. Additionally, the user may be represented by an avatar in the virtual environment, and the user's movements can be tracked by the HMD using various sensors to animate the user's avatar.

AR and MR refer to a type of XR that includes some mixture of the real environment and virtual content. For example, a user may hold a tablet that includes a camera that captures images of the user's real environment. The tablet may have a display that displays the images of the real environment mixed with images of virtual objects. AR or MR can also be presented to a user through an HMD. An HMD can have an opaque display, or can use a see-through display, which allows the user to see the real environment through the display, while displaying virtual content overlaid on the real environment.

The methods described herein may be implemented in software, hardware, or a combination thereof, in different embodiments. In addition, the order of the blocks of the methods may be changed, and various elements may be added, reordered, combined, omitted, modified, etc. Various modifications and changes may be made as would be obvious to a person skilled in the art having the benefit of this disclosure. The various embodiments described herein are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

What is claimed is:

1. A device, comprising:
a camera configured to capture images of an eye; and
a controller comprising one or more processors configured to:
initiate a user authentication process;
cause an image to be captured of a current eye under a first set of conditions;
transform the image into a current feature representation for the current eye;
access a multi-representation eye model, wherein the multi-representation eye model is based on feature representations of images of an identified eye captured under a plurality of different sets of conditions;
apply the current feature representation to the multi-representation eye model to determine whether the current eye is a match for the identified eye; and
provide indication of whether the current eye is a match for the identified eye.

2. The device of claim 1, wherein to apply the current feature representation to the multi-representation eye model, the controller is further configured to compare features of the current feature representation to features of the multi-representation eye model.

3. The device of claim 2, wherein the features of the current feature representation and the features of the multi-representation eye model represent different 3D topography, structures, or textures of the current eye captured under the first set of conditions or of the identified eye under the different sets of conditions.

4. The device of claim 2, wherein the features of the current feature representation comprise dependent features dependent on the first set of conditions and independent features independent of the first set of the conditions, and the features of the multi-representation eye model comprise a plurality of different sets of dependent model features dependent on the plurality of the different sets of conditions and a set of independent model features independent of the different sets of conditions, wherein to compare the features of the current feature representation to the features of the multi-representation model the controller is further configured to compare the dependent current features to the plurality of different sets of dependent model features and to compare the independent current features to the set of independent model features.

5. The device of claim 1, wherein the multi-representation eye model comprises different feature representations for each of the different sets of conditions.

6. The device of claim 5, wherein to apply the current feature representation to the multi-representation eye model, the controller is further configured to:
identify the first set of conditions of the current feature representation;
determine corresponding one or more feature representations of the multi-representation eye model based on the first set of conditions; and
compare the current feature representation to the one or more corresponding feature representations.

7. The device of claim 1, wherein the first set of conditions and the plurality of the different set of conditions comprise one or more of: lighting affecting the current eye or the identified eye, pose of the current eye or the identified eye, accommodation distance for the current eye or the identified eye, or indication of force applied to the current eye or the identified eye.

8. A device, comprising:
a camera configured to capture images of an eye; and
a controller comprising one or more processors configured to:
cause a first image of the eye to be captured at a first time under a first set of conditions when the eye is an identified eye;
transform the first image into a first feature representation for the identified eye;
cause a second image of the identified eye to be captured at a second time after the first time under a second set of conditions different than the first set of conditions;
transform the second image into a second feature representation for the identified eye;
configure a multi-representation eye model for the identified eye, wherein to configure the multi-representation eye model for the identified eye the controller is configured to:
generate, based on at least the first feature representation and the second feature representation, the multi-representation eye model for the identified eye, or
successively update the multi-representation eye model for the identified eye based on the first feature representation and the second feature representation; and
store the multi-representation eye model for use during a user authentication process.

9. The device of claim 8, wherein the processors are configured to initiate an enrollment process for eye authentication for a user, wherein the first image and the second image are captured as part of the enrollment process and the controller generates the multi-representation eye model as part of the enrollment process based on at least the first feature representation and the second feature representation.

10. The device of claim 8, wherein the first set of conditions and the second set of conditions comprise one or more of: lighting affecting the identified eye, pose of the identified eye, accommodation distance for the identified eye, or indication of force applied to the identified eye.

11. The device of claim 8, wherein the device further comprises a display configured to be positioned in front of the eye, wherein the controller is configured to control the display to at least partially create the first set of conditions for capturing the first image and the second set of conditions for capturing the second image.

12. The device of claim 11, wherein to at least partially create the first set of conditions and the second set of conditions the controller is configured to:
change the brightness of the display to provide a different brightness for the second set of conditions than the first set of conditions, or
change a depth appearance of an object on the display to provide a different accommodation distance for the second set of conditions than the first set of conditions.

13. The device of claim 8, wherein features of the first feature representation and features of the second feature representation represent different 3D topography, structures, or textures of the identified eye captured under the first set of conditions and under the second set of conditions.

14. The device of claim 8, wherein to generate or update the multi-representation eye model the controller is configured to train a machine learning model for the multi-representation eye model using the first feature representation and the second feature representation.

15. The device of claim 8, wherein to generate or update the multi-representation eye model the controller is configured to separately store the first feature representation and the second feature representation as part of the multi-representation eye model.

16. The device of claim 8, wherein the controller is further configured to:
determine a new set of conditions affecting the identified eye;
determine whether the new set of conditions are sufficiently represented in the multi-representation eye model;
capture, based on a determination that the new set of conditions are not sufficiently represented in the multi-representation eye model, a new image of the identified eye under the new set of conditions;
transform the new image into a new feature representation for the identified eye; and
update the multi-representation eye model for the identified eye based on the new feature representation.

17. The device of claim 16, wherein to update the multi-representation eye model for the identified eye based on the new feature representation the controller is configured to replace an existing feature representation of the multi-representation eye model with the new feature representation based on a quality indicator for the existing feature representation or an age of the existing feature representation.

18. A method, comprising:
performing, by a controller comprising one or more processors:
initiating a user authentication process;
causing an image to be captured of a current eye under a first set of conditions;
transforming the image into a current feature representation for the current eye;
accessing a multi-representation eye model based on feature representations of images of an identified eye captured under a plurality of different sets of conditions;
applying the current feature representation to the multi-representation eye model to determine whether the current eye is a match for the identified eye; and
providing indication of whether the current eye is a match for the identified eye.

19. A method, comprising:
performing, by a controller comprising one or more processors:
causing a first image of the eye to be captured at a first time under a first set of conditions when the eye is an identified eye;
transforming the first image into a first feature representation for the identified eye;
causing a second image of the identified eye to be captured at a second time after the first time under a second set of conditions different than the first set of conditions;
transforming the second image into a second feature representation for the identified eye;
configuring a multi-representation eye model for the identified eye, wherein to configure the multi-representation eye model for the identified eye the controller is configured to:
generate, based on at least the first feature representation and the second feature representation, the multi-representation eye model for the identified eye, or
successively update the multi-representation eye model for the identified eye based on the first feature representation and the second feature representation; and
storing the multi-representation eye model for use during a user authentication process.
